(19) United States
(12) Patent Application Publication
(10) Pub. No.: US 2011/0261718 A1
(43) Pub. Date: Oct. 27, 2011

(54) Method, System and Device for Facilitating Data Communication

(75) Inventors: Mats Johan DAHLSTEDT, Scarborough (AU); Patrick REHN, Mundingburra (AU)

(73) Assignee: MOBILE IP PTY LTD, Scarborough (AU)

(21) Appl. No.: 13/176,564

(22) Filed: Jul. 5, 2011

Related U.S. Application Data
(63) Continuation of application No. 11/939,549, filed on Nov. 13, 2007.
Application No. 11/939,549 is a continuation of application No. PCT/AU06/00622, filed on Mar. 12, 2006.

(30) Foreign Application Priority Data
May 13, 2005 (AU) 2005100399

(51) Int. Cl. H04W 24/00; H04L 12/26

(52) U.S. Cl. 370/252

(57) ABSTRACT

Data communication is facilitated in a mobile network in a general communication network, the mobile network being formed from a mobile router in communication with a plurality of network nodes. One method of facilitating the data communication includes, at the mobile router, determining the availability of one or more access bearers from a group thereof, each access bearer providing an access gateway to a communication network. The mobile router then automatically selects at least one available access bearer based upon a prioritized list containing two or more access bearers, the prioritized list indicating an order of preference. The mobile router then connects to the selected access bearer using an access communication technology compatible with the selected access bearer to allow each of the network nodes of the mobile network to communicate with correspondent nodes of the communication network via the access gateway provided by the access bearer.

### CROSS-REFERENCE TO RELATED APPLICATIONS

This application is a continuation of U.S. application Ser. No. 11/939,549, filed Nov. 13, 2007, which application claims the benefit of and priority to International Application No. PCT/AU2006/000622, entitled “A Method, System and Device for Facilitating Data Communication,” filed on Mar. 12, 2006, which claims the benefit of and priority to Australian Patent Application No. 2005100399, filed May 13, 2005, both of which are incorporated herein by reference in their entireties.

### BACKGROUND OF THE INVENTION

1. The Field of the Invention

The invention relates to a method, system and device for facilitating data communication. In particular, although not exclusively, the invention relates to a method, system and device for facilitating data communication in a mobile cellular communication network.

2. The Relevant Technology

Recently, there has been a proliferation of mobile data communication devices, such as laptops, smart phones and the like, requiring Internet connectivity. It is well known in the art to provide for a wireless local area network (WLAN) to enable connectivity of these devices with the Internet by way of a router hardwired to the Internet infrastructure. The mobile data communication devices connect to the wireless router and are assigned an IP address based on the wireless router.

Whilst the above caters well for static networks, such as in offices and homes, there exists the need to provide for wireless local area networks in mobile environments. The communications industry has begun to cater for the mobile wireless local area network with, for example, Cisco releasing it's general purpose 3200 Series Wireless and Mobile Router that can be embedded within a vehicle.

In static networks, the wireless router is generally physically wired to the Internet infrastructure and provides wireless data communication within a certain signal range in order that mobile data communication devices are able to wirelessly connect to the router, for example via the 802.11x series of wireless communication protocols, and hence to the Internet infrastructure.

However, in mobile wireless local area networks, the mobile wireless router is connected to the Internet infrastructure via a wireless communication pathway such as a 3G telecommunications network, a CDMA telecommunications network, a wireless broadband network, satellite communication or the like and the mobile data communication devices are wirelessly connected to the mobile router.

The provision of mobile networks is desirable in public transport applications, such as buses, ferries, trains and the like, for law enforcement and emergency applications where the mobile wireless router is located upon the emergency response vehicle, news and media applications and other applications.

However, there are a range of problems associated with communication in wireless mobile networks. For example, the mobile communications devices, referred to in the art as mobile network nodes, are separately addressable devices with data packets intended for a particular device having that devices' IP address as the destination address of the packet. As vertical mobility occurs, that is, the mobile network moves between different access technologies (from wideband to wireless local area network (WLAN) in order that connectivity of the network nodes with the Internet is maintained, addressing issues in respect of the nodes arises.

Similarly, consistent IP connectivity is difficult to maintain as the mobile network moves between different communications providers of the same access technology.

U.S. Pat. No. 6,721,297 describes a method and apparatus for providing IP mobility for mobile networks. This document identifies the problem with maintaining consistent IP connectivity for mobile network nodes as the mobile network undergoes vertical mobility and provides a solution to support this mobility.

As the mobile network moves from a home network to a foreign network, the mobile router obtains a multicast care of address on behalf of the attached mobile network nodes and creates a binding between the mobile subnet prefix and the multicast care of address. The mobile router communicates the binding information, via binding update messages, to a home agent.

When a correspondent node (not associated with the mobile network) sends data packets to a mobile networks nodes' home address, they are intercepted by the home agent and tunnelled to the mobile router via the multicast care of address. The mobile router receives the packet and forwards the packet to the targeted mobile network node. Optionally, the mobile router may also send a binding update to the correspondent node so that future packets may travel the shortest tree and thus avoid the overhead of tunnelling.

U.S. Pat. No. 6,721,297 also provides for the mobile router having only two network interfaces with each network interface being able to connect the router to a dissimilar access technology in order to provide data connectivity to the mobile nodes forming the mobile network. In the embodiment, the mobile router has two access interfaces with one access interface able to connect to a first site via a first wireless access technology in the form of WLAN and a second access interface of the router able to connect to a second site via a second wireless access technology in the form of SAM (Scaleable Amplitude Modulation).

The mobile router actively monitors its interfaces to determine its accessibility to the external networks (sites) and determines whether it should perform a vertical handoff (i.e. switch the router connectivity from one access site to another) depending upon the accessibility of the mobile router to the respective external networks (sites).

As such, it is desirable to provide a method, system and device for facilitating data communication that addresses at least some of the above issues relating to mobile networks.

### BRIEF SUMMARY OF THE INVENTION

Accordingly, embodiments of the invention overcome or at least alleviate one or more of the above problems and/or provide the consumer with a useful or commercial choice. Embodiments of the invention also provide a router and vertical hand-off algorithm with greater flexibility and versatility than is currently known.

In one form, although it need not be the only or indeed the broadest form, the invention resides in a method for facilitating data communication in a mobile network formed from a mobile router and a plurality of network nodes in communication with the mobile router, the mobile network able to roam about a general communication network infrastructure, the method including the following steps at the mobile router:

(i) determining the availability of one or more access bearers from a group of access bearers, each access bearer in the group of access bearers providing an access gateway to a communication network;

(ii) automatically selecting at least one available access bearer based upon a prioritized list containing two or more access bearers, the prioritized list indicating an order of preference of the access bearers in the group of access bearers; and

(iii) connecting the mobile router to the at least one selected access bearer using an access communication technology compatible with the at least one selected access bearer to thereby allow each of the plurality of network nodes of the mobile network to communicate with correspondent nodes of the communication network via the access gateway provided by the at least one selected access bearer.

In a further form, the invention resides in a mobile router comprising:

at least one network communication module for communication with one or more network nodes, the mobile router and the one or more network nodes together forming a mobile network;

two or more external communication modules, each communication module able to communicate with at least one access bearer from a group of access bearers, the access bearers providing an access gateway to a communication network; and
a processing and storage module in communication with the at least one network communication module and the two or more external communication modules, the processing and storage module having machine readable code for:
   determining the availability of one or more access bearers from the group of access bearers by monitoring at least one of the two or more external communication modules;
   automatically selecting at least one available access bearer based upon a prioritized list containing two or more access bearers, the prioritized list indicating an order of preference of the access bearers in the group of access bearers; and
   connecting at least one of the external communication modules to the at least one selected access bearer, the at least one external communication module using an access communication technology compatible with the at least one selected access bearer to thereby allow the one or more network nodes of the mobile network to communicate with correspondent nodes of the communication network via the access gateway provided by the at least one selected access bearer.

These and other features of the present invention will become more fully apparent from the following description and appended claims, or may be learned by the practice of the invention as set forth hereinafter.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a system for facilitating data communication in a mobile network according to an embodiment of the invention;

FIG. 2 shows a functional block diagram of a mobile router forming part of the system shown in FIG. 1;

FIG. 3 shows a method for facilitating data communication in a mobile network according to an embodiment of the invention;

FIG. 4 shows the system for facilitating data communication in a mobile network shown in FIG. 1 having a VPN server in communication therewith;

FIG. 5 shows the system of facilitating data communication in a mobile network shown in FIG. 1 applied to a security application;

FIG. 6 shows the system of facilitating data communication in a mobile network shown in FIG. 1 applied to a remote control/telemetry application; and

FIG. 7 shows a method of dynamically creating a prioritized listing of access bearers forming part of the method shown in FIG. 3.

### DETAILED DESCRIPTION OF THE INVENTION

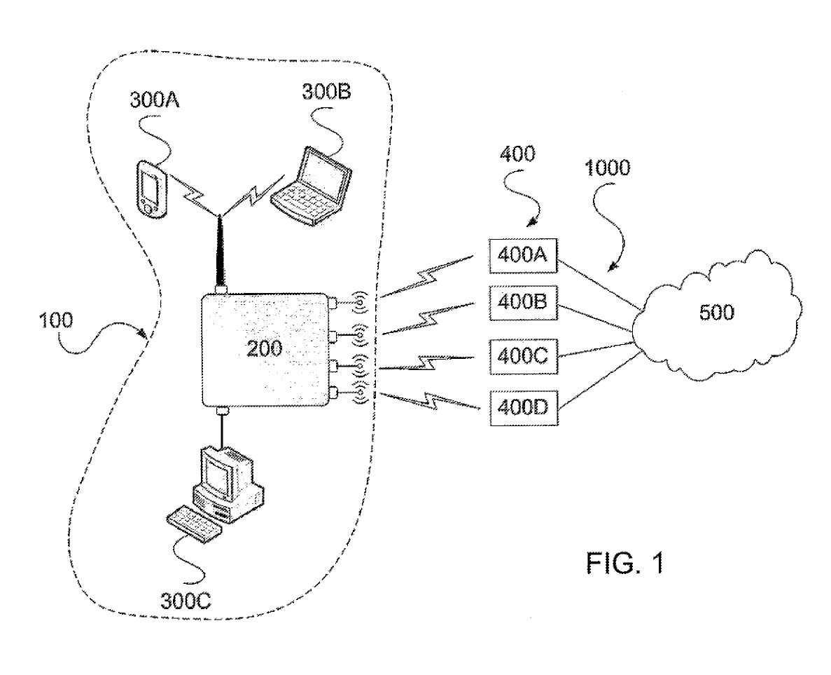

FIG. 1 shows a system 1000 for facilitating data communication in a mobile network according to an embodiment of the invention: System 1000 comprises a mobile router 200, a plurality of network nodes 300 in communication with the mobile router 200 defining a mobile network 100, a plurality of access bearers 400 and communications network 500 in the form of the Internet.

Mobile router 200 is a wireless router as is known in the art and together with network nodes 300 forms mobile network 100. Suitably, the mobile network 100 is in the form of a wireless local area network providing data communication using the 802.11 series of wireless communication protocols. Optionally, the mobile router 200 also provides a wired network (i.e. standard LAN) in order that one or more network nodes 300 are able to be in communication with mobile router 200. Mobile router 200 is discussed in greater detail below.

Network nodes 300A and 3008 are in wireless communication with mobile router 200 and are in the form of computing devices having wireless communication technology such as smart phones 300A, laptops 300B, telemetry equipment, digital cameras or the like.

Optionally, one or more network nodes 300C may be in physical communication with mobile router 200 by way of an Ethernet connection or the like to form a LAN as is known in the art.

As previously discussed, mobile network 100 is formed by network nodes 300 being in communication with mobile router 200. Mobile network 100 is able to physically roam around a general communications network infrastructure and may be located on a train, bus or other mobile infrastructure as will be discussed in greater detail below.

Mobile router 200 is in wireless communication with one or more access bearers 400A-D from a group of access bearers 4 at anyone time. Each access bearer 400A-D provides an access gateway in order that mobile router 200 is able to access communications network 500 in the form of the Internet.

Preferably, each access bearer 400A-D of the group of access bearers 400 provides a distinct access communication technology pathway from mobile router 200 to the relevant access bearer 400.

For example, access bearer 400A may be an access gateway accessible via Wireless Wide Area Network (WWAN) technology in order that mobile router 200 is in communication with communications network 500 in the form of the Internet, access bearer 400B may be an access gateway accessible via Wideband Code-Division Multiple Access (W-CDMA) technology in order that mobile router 200 is in communication with communications network 500 in the form of the Internet, access bearer 400C may be an access gateway accessible via a Code-Division Multiple Access (CDMA) technology (e.g. 1xRTT/Ev-Do) in order that mobile router 200 is in communication with communications network 500 in the form of the Internet and access bearer 4000 may be an access gateway accessible via a steerable satellite dish for data transmission via satellite technology in order that mobile router 200 is in communication with communications network 500 in the form of the Internet.

Optionally, two or more of the access bearers in the group of access bearers 400 available to mobile router 200 provides the same access communication technology pathway but are access gateways provided by separate communication providers. For example, both access bearers 400A and 400B may be accessible via W-CDMA technology but are access gateways offered by a first communication provider and a second communication provider respectively.

Whilst the embodiment shown in FIG. 1 has the group of access bearers 400 having four separate access bearers 400A-D, a skilled person will appreciate that this is exemplary only and that the group of access bearers 400 may have three or more access bearers 400.

Hence, each network node 300 within the mobile network 100 is in communication with mobile router 200 which in turn is in communication with one or more access bearers 400A-D from a group 400 of three or more access bearers with the access bearers providing an access gateway to communications network 500 in the form of the Internet in order that each network node 300 is in communication with communications network 500.

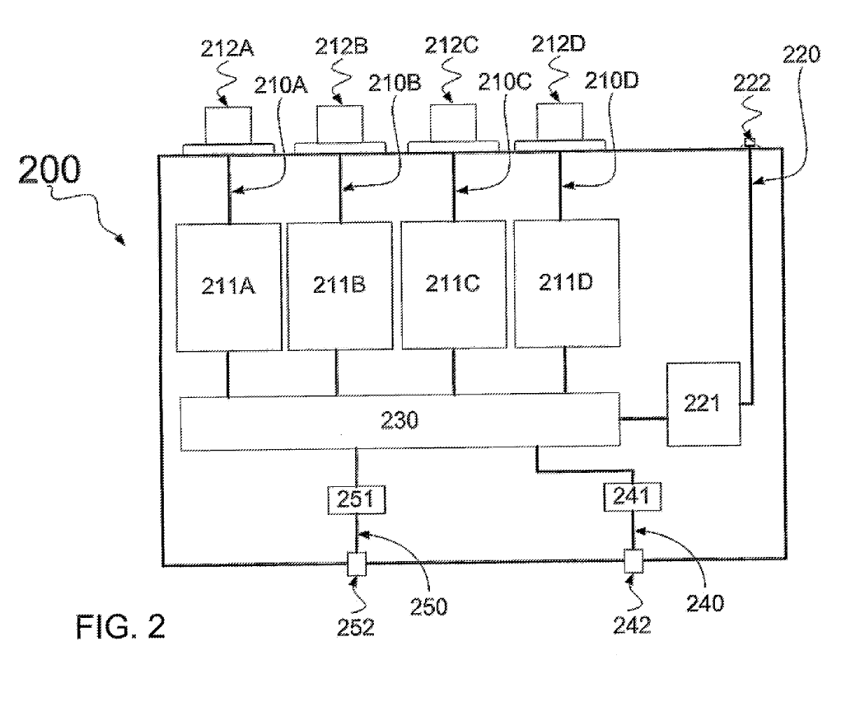

FIG. 2 shows a functional block diagram of mobile router 200. Mobile router 200 has a processing and storage module 230, a plurality of external communication modules 210, a WLAN communication module 220, a power module 250 and a LAN communication module 240.

Processing and storage module 230 has processing and storage capabilities. Suitably, the processing and storage module 230 is embodied by a processor having processing and storage capabilities as is known in the art.

External communication modules 210 are in communication with processing and storage module 230. Each external communication module 210 has an access technology interface 212 for wireless communication with a respective access bearer 400A-D from the group of access bearers 400 and a communication processing module 211. Suitably, each access technology interface 212 is in the form of an antenna, a steerable satellite dish or the like in order to facilitate communication with a respective access bearer 400A-D and each communication processing module 211 is adapted to receive data packets from it's respective access technology interface 212, process these data packets and communicate them to processing and storage module 230.

Preferably, each external communication module 210 is adapted to communicate with a respective access bearer 400A-D within the group of access bearers 400 by way of different access communication technology. For example, external communication module 2108 has an access technology interface 2128 able to communicate with access bearer 4008 via W-CDMA access communication technology.

Optionally, of the plurality of external communication modules 210 forming part of mobile router 200, two or more of the external communication modules 210 may be adapted to simultaneously communicate with a respective access bearer 400A-D from the group of access bearers 400 using the same access technology.

Suitably, two or more external communication modules 210 are able to communicate with two or more access bearers 400A-D from the group of access bearers 400 simultaneously with each external communication module 210 communicating using a different access communication technology.

Whilst the embodiment of the mobile router 200 shown in FIG. 2 has four external communication modules 210A-D, a skilled person will realize that this is an exemplary embodiment only and that mobile router 200 may have three or more external communication modules 210.

Mobile router further comprises a WLAN communication module 220 adapted for wireless communication with the one or more network nodes 300 forming part of the mobile network 100. WLAN communication module 220 has a WLAN communication interface 222 in the form of an antenna or the like and a WLAN communication processing module 221 in communication with processing and storage module 230.

A LAN communication module 240 forms part of mobile router 200 and has a LAN communication interface 242 for communication with one or more network nodes 300 and a LAN communication processing module 241 in communication with processing and storage module 230. Suitably, LAN communication module 240 is in the form of an Ethernet communication module as is known in the art in order that network nodes 300 are able to communicate with mobile router 200.

Mobile router 200 further comprises a power module 250 having a power interface 252 and a power regulation module 251 in order to supply power to mobile router 200. Optionally, power module 250 is in the form of a battery or the like in order that mobile router 200 does not require an external power source to operate.

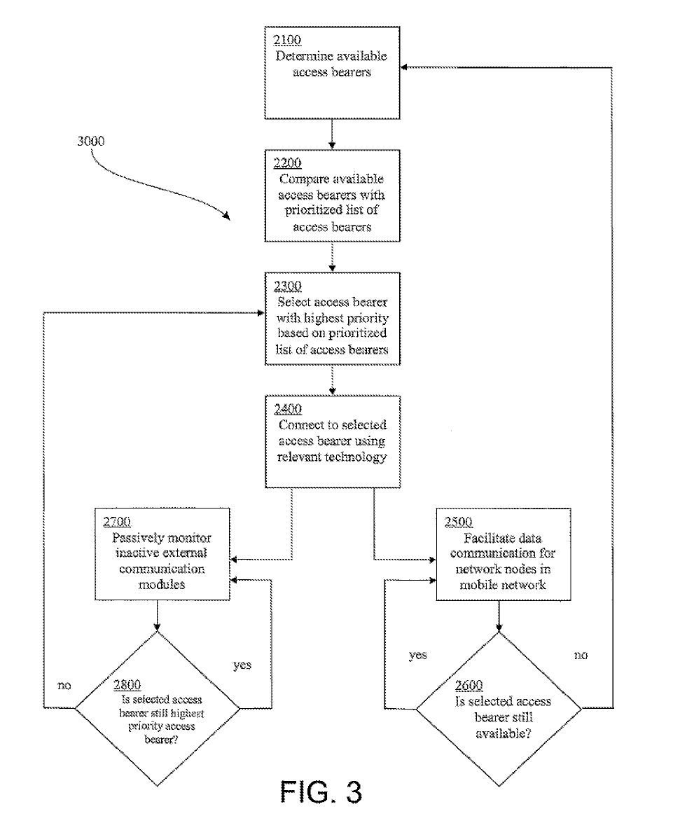

FIG. 3 shows a method 2000 of facilitating communication according to an embodiment of the invention. The method commences when power is supplied to the mobile router 200. The processing and storage module 230 of the router determines which of the access bearers 400A-D from the group of access bearers 400 are available (step 2100).

Preferably, this is carried out by processing and storage module 230 of mobile router 200 passively monitoring each of the external network communication modules 210 for detection of network traffic.

For example, the processing and storage module 230 of mobile router 200 is a passive receiver of data received at each of the external communication modules 210. In the absence of receipt of data at an external communication module 230, the respective access bearer 400 is deemed to be unavailable.

Alternatively, processing and storage module 230 may actively probe the group of access bearers 400 via corresponding external communication modules 210 to detect the available access bearers 400A-D from the group of access bearers 400.

For example, the processing and storage module 230 of the mobile router 200 actively pings the access bearer's via a respective external communication module 210 in order to determine the availability of the access bearers 400 in the group.

Once the available access bearers 400A-D from the group of access bearers 400 have been determined, the processing and storage module 230 of the mobile router 200 compares the available access bearers 400A-D with a prioritized list of access bearers stored within the processing and storage module 230 (step 2200).

Not all access bearers 400A-D from the group of access bearers 400 may be available access bearers due to the fact that, as mobile network 100 roams about the general communication network infrastructure, some access bearers 400 may not be within the range of mobile router 200.

Suitably, the prioritized list of access bearers 400 is predetermined by an operator of mobile router 200 and is a list of preferred access communication technologies in order of most preferred to least preferred.

For example, the prioritized list of access bearers 400 may have WLAN as the most preferred access communications technology, W-CDMA as the next most preferred access communication and satellite as the least preferred access communications technology.

Alternatively, the prioritized list of access bearers 400 is predetermined by an operator of mobile router 200 based on a characteristic of the access communication technology of each access bearer such as the price of connection to an access bearer or the bandwidth of the communication pathway for that access bearer and similar such characteristics.

Optionally, the prioritized list of access bearers 400 is predetermined by an operator of mobile router 200 based upon preference of connection to different communication providers. That is, the operator of mobile router 200 may indicate, for example, communication provider A as the most preferred, communication provider B as the next most preferred and communication provider C as the least preferred without any regard to access communication technology offered by the available access bearers 400 operated by the communications providers.

Alternatively, the prioritized list of access bearers 400 may be configured dynamically based upon a metric as will be discussed in detail below.

The processing and storage module 230 of the mobile router 200 then selects the highest priority available access bearer 400 (step 2300).

Suitably, the processing and storage module 230 of the mobile router 200 compares each available access bearer with the prioritized listing as the availability of each access bearer is made known to the processing and storage module 230 and, if the most preferred access bearer is available, the mobile selects this access bearer without determining whether other access bearers are available.

The processing and storage module 230 then connects the relevant external communication module 210 to the selected access bearer (step 2400) with the relevant external communication module 210 becoming the active external communication module. As such, mobile router 200 is in communication with the selected access bearer 400 via a communication pathway in the form of the access communication technology of the selected access bearer 400.

Processing and storage module 230 of mobile router 200 is then able to facilitate data transfer between network nodes 300 and communications network 500 in the form of the Internet (step 2500). A data packet is received at the mobile router 200 from a network node 300 at either the WLAN communications module 220 or the LAN communications module 240 and forwarded to processing and storage module 230. The processing and storage module 230 then determines which of the external communication modules 210 is currently the active external communication module 210 and communicates the data packet to the active communication module 210 for communication to communications network 500 via the access gateway provided by the selected access bearer 400 for final delivery to the intended correspondent node (not shown in FIG. 2 or FIG. 3).

A skilled person will appreciate that a similar process is followed for communicating a data packet form the correspondent node (not shown) to a network node 300 in the mobile network 100.

The processing and communication module 230 continually monitors the active external communication module 210 to determine whether the selected access bearer 400 is still available (step 2600). Preferably, the processing and storage module 230 passively monitors the active external communication module 210.

For example, if no data traffic is detected over the active external communication module for a period of time, processing and storage module 230 then determines what access bearers 400 from the group of access bearers is available (step 2100) and the process of connection to a gateway provided by the access bearers commences again.

Alternatively, the processing and storage module 230 actively monitors the active external communication module 210 by, for example, periodically pinging the selected access bearer 400.

If the active external communication module 210 is still available, the processing and storage module 230 continues to facilitate data communication (step 2500) as previously discussed.

Additionally, in parallel with steps 2500 and 2600, the processing and storage module 230 passively monitors the inactive external communication modules 210 (step 2700) to determine whether the selected access bearer 400 is still the highest priority (i.e. most preferred) available access bearer 400 based on the prioritized list of access bearers 400 stored within the processing and storage module (step 2800). As such, in step 2800 the processing and storage module undertakes step 2100 and 2200 previously described.

If the selected access bearer 400 is not the most preferred available access bearer based on the prioritized list of access bearers, the processing and storage module 230 then returns to step 2300 to select a new access bearer 400.

Suitably, the processing and storage module 230 buffers any outgoing data packets from the network nodes 300 whilst the mobile router selects and connects to a new available access bearer 400.

As discussed above, the processing and storage module 230 may optionally have one or more active external communication modules 210 each in communication with an access bearer 400 in order to facilitate load sharing in that the processing and storage module 230 is able to communicate data packets through separate communication channels in order that they may be reassembled at the user.

In this way, the processing and storage module 230 is configured to direct data packets between the network nodes 300 and the one or more external network modules 210 to facilitate higher bandwidth communication between the network nodes 300 and communications network 500.

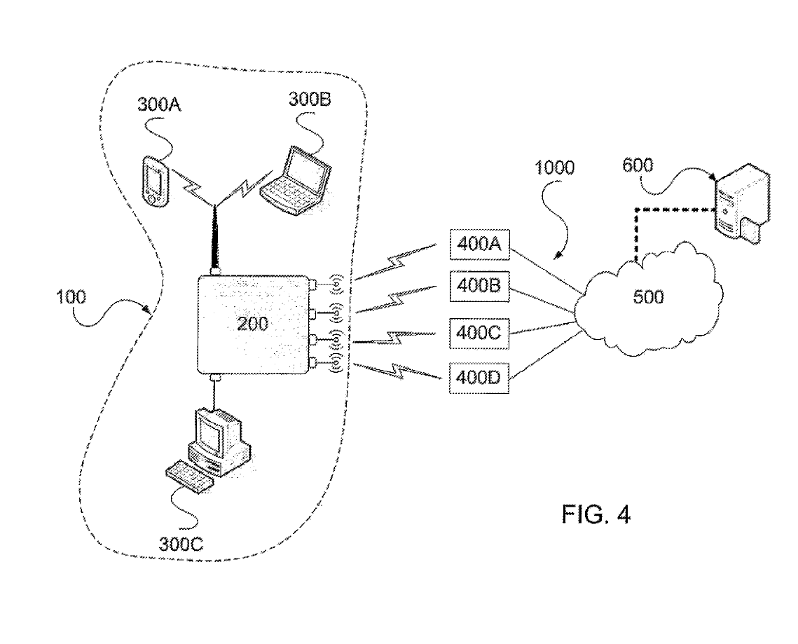

FIG. 4 shows the system 1000 for facilitating data communication of the invention optionally including a Virtual Private Network (VPN) server 600 in communication with communications network 500 in the form of the Internet.

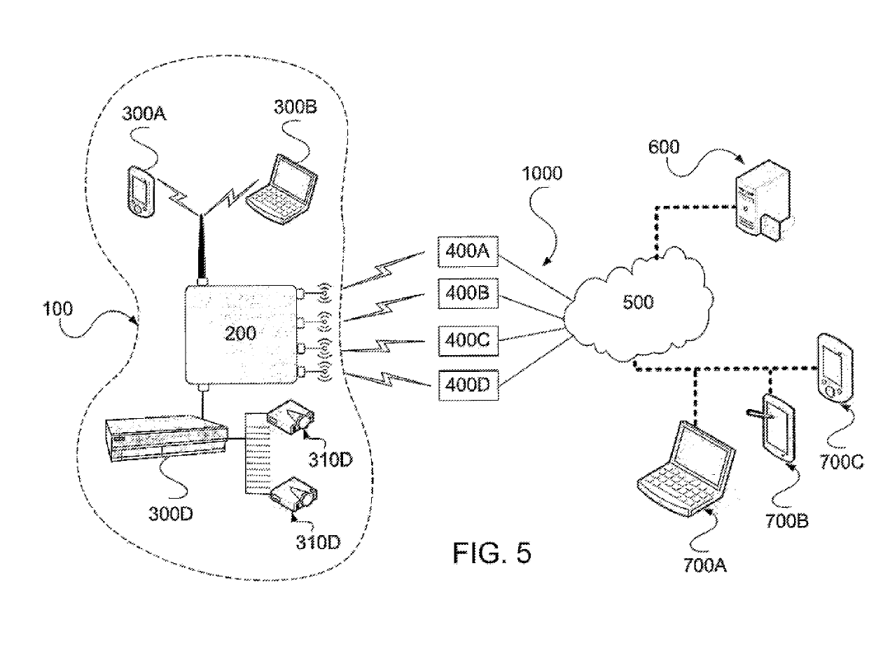

System 1000 optionally includes VPN server 600 for applications where a high level of data security is required or a reliable communication pathway between network nodes 300 and one or more correspondent nodes (not shown in FIG. 5) in communication with network 500.

When mobile router 200 connects to communications network 500 via the access gateway provided by the selected access bearer 400 in step 2400 in FIG. 2, the mobile router 200 then communicates with VPN server 600 and routes all data packets communicated from network nodes 300 to VPN server 600 which in turn forwards the data packets to an intended correspondent node (not shown).

Similarly, the VPN server 600 intercepts data packets communicated over network 500 intended for a network node 300 and routes the data packets to mobile router 200 for subsequent communication to the intended network node 300.

Furthermore, the VPN server 600 supports the load sharing feature discussed above in that the VPN server 600 is able to assemble data packets communicated between network nodes 300 and correspondent nodes (not shown) in order that they are maintained in the correct order.

Additionally, the VPN server facilitates a seamless transaction when the mobile router 200 determines that a move between selected access bearers 400 is necessary or desirable (i.e., steps 2600 and 2800 respectively). When the selected. access bearer 400 of the mobile router 200 is changed, there is a small lag whilst communication with network 500 is re-established. In this time, VPN server 600 continues to receive data packets intended for network nodes 300 so that, for example, if a network node 300 is partially through a file transfer or the like, the communication process may recommence when the network router 200 has re-established connection with the VPN server 600 via the access gateway provided by the new selected access bearer 400.

FIG. 5 shows the system 1000 of facilitating data communication of the invention applied to a security application. In this example, correspondent nodes 700 in the form of, for example, laptop 700A, PDA 700B and smart phone 700C, are in communication with communications network 500 in the form of the Internet 500.

A network node 3000 in the form of a OVR transceiver having cameras 3100 connected thereto forms part of mobile network 100 with network node 3000 being in communication with mobile router 200.

Network node 3000 digitizes and compresses, if necessary, images captured by cameras 3100 and forwards the data packets to mobile router 200 through wireless mobile network 100. The mobile router 200 then forwards the data packets to the VPN server 600 over network 500 by way of the access gateway provided by the one or more selected access bearers 400. The data packets are then routed to the destination correspondent node 700 by VPN server 600.

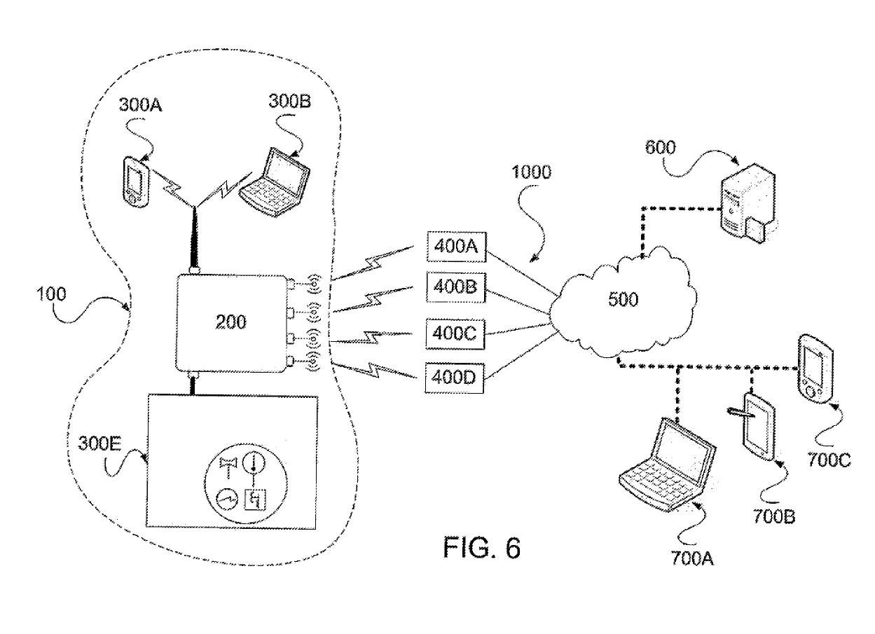

FIG. 6 shows the system 1000 of facilitating data communication of the invention applied to a remote control and telemetry application. In this example, a network node 300E in the form of remote control and telemetry equipment forms part of mobile network 100 and is in communication with mobile router 200.

The remote control and telemetry equipment 700E forwards telemetry data packets to intended correspondent nodes 700 via VPN server 600 and receives control instructions from correspondent nodes 700 via VPN server as discussed above.

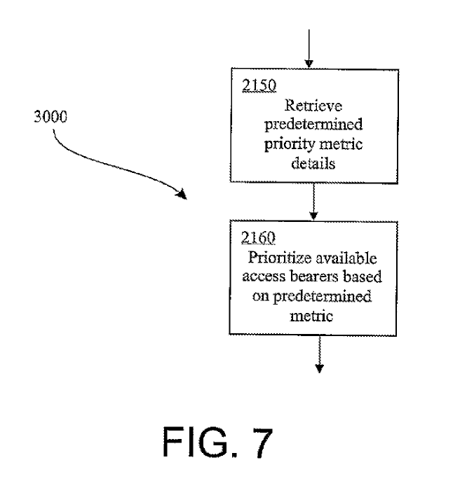

FIG. 7 shows a method of dynamically altering the prioritized listing of access bearers 400. As discussed above, processing and storage module 230 of mobile router 200 optionally dynamically generates the prioritized list of access bearers based on a predetermined metric applied to the available access bearers determined in step 2100.

For example, the same communication access technology in one region of the general communication network infrastructure may have different characteristics in a different region in terms of cost, bandwidth, bit rate, reliability, etc. and hence it may not be plausible to predetermine the prioritized listing of access bearers 400 as the most preferred access bearer 400 in one portion of the general communication network infrastructure may not be the most preferred access bearer in another.

After determining the available access bearers in step 2100, the processing and storage module 230 retrieves the predetermined priority metric (step 2150) and dynamically generates the prioritized list of access bearers based on this metric (step 2160). The most preferred access bearer 400 is then selected based on this dynamically generated prioritized list of access bearers 400 (step 2300).

It will be appreciated that the dynamic creation of the prioritized listing of available access bearers 400 also occurs during step 2800 as the processing and storage module 230 passively polls the inactive external network communication modules 210.

Optionally, the predetermined metric may be a weighted metric comprised of a variety of characteristics with each characteristic being given a relative weight (i.e. bandwidth weighted at 0.8 and cost at 0.2).

The system and method of the invention provides for an efficient and flexible solution for facilitating data communication for network nodes in a mobile network as the mobile network roams about a general communication network infrastructure. As the mobile router is able to adaptively select from three or more access bearers each providing an access gateway to the Internet, the network nodes are assured of remaining in data communication with the Internet.

Furthermore, as the mobile router selects the most preferred access bearer from the group containing three or more access bearers, the operator of the mobile router is able to ensure that the data communication will always meet an optimized predetermined set of criteria whenever it is possible to do so.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for facilitating data communication in a mobile network formed from a mobile router and a plurality of network nodes in communication with the mobile router, the mobile network able to roam about a general communication network infrastructure, the method including the following steps at the mobile router:
(i) determining the availability of one or more access bearers from a group of access bearers by passively monitoring the presence or absence of data traffic at one or more external communication modules of the mobile router, each access bearer in the group of access bearers providing an access gateway to a communication network;
(ii) automatically selecting at least one available access bearer based upon a prioritized list containing two or more access bearers, the prioritized list indicating an order of preference of the access bearers in the group of access bearers;
(iii) connecting the mobile router to the at least one selected access bearer using an access communication technology compatible with the at least one selected access bearer to thereby allow each of the plurality of network nodes of the mobile network to communicate with correspondent nodes of the communication network via the access gateway provided by the at least one selected access bearer;
(iv) continuously determining the availability of the one or more access bears from the group of access bearers; and
(v) determining whether the selected access bearer is the most preferred access bearer in the prioritized list of access bearers.

2. The method of claim 1, wherein communication with each of the one or more access bearers in the group of access bearers occurs using a different access communication technology.

3. The method of claim 1, wherein communication with two or more of the access bearers of the group of access bearers occurs using the same access communication technology.

4. (canceled)

5. (canceled)

6. The method of claim 1, wherein each of the access bearers in the group of access bearers are operated by a single telecommunications provider.

7. The method of claim 1, wherein at least two of the access bearers in the group of access bearers are operated by a different telecommunications provider.

8. The method of claim 1, further including the step of:
(vi) communicating with a Virtual Private Network (VPN) server in communication with the communication network in order that all communication between the network nodes and the correspondent nodes over the communication network is routed through the VPN server.

9. The method of claim 1, wherein the mobile router selects a new access bearer and connects to the new access bearer if the current selected access bearer is not the most preferred access bearer in the prioritized list of access bearers.

10. The method of claim 1, further including the step of:
(vi) determining whether the selected access bearer is still an available access bearer.

11. The method of claim 10, wherein, if the selected access bearer is not an available access bearer, the mobile router undertakes the steps of:
(vii) determining the availability of the one or more access bearers from the group of access bearers;
(viii) automatically selecting at least one available access bearer based upon the prioritized list of access bearers; and
(ix) connecting the mobile router to the least one selected access bearer.

12. The method of claim 1, wherein the mobile router selects two available access bearers in step (ii) such that the mobile router is connected to the two access bearers simultaneously.

13. The method of claim 12, wherein the network nodes of the mobile network are in communication with the correspondent nodes via the access gateways to the communication network provided by the two selected access bearers.

14. The method of claim 1, wherein the prioritized list of access bearers is a predetermined list of access bearers.

15. The method of claim 1, wherein the mobile router dynamically generates the prioritized list of access bearers based upon a predetermined metric applied to characteristics of the available access bearers.

16. The method of claim 1, wherein the predetermined metric is a weighted metric.

17. A mobile router comprising:
at least one network communication module for communication with one or more network nodes, the mobile router and the one or more network nodes together forming a mobile network;
two or more external communication modules, each communication module able to communicate with at least one access bearer from a group of access bearers, the access bearers providing an access gateway to a communication network; and
a processing and storage module in communication with the at least one network communication module and the two or more external communication modules, the processing and storage module having machine readable code for:
determining the availability of one or more access bearers from the group of access bearers by passively monitoring the presence or absence of data traffic at least one or more of the two or more external communication modules;
automatically selecting at least one available access bearer based upon a prioritized list containing two or more access bearers, the prioritized list indicating an order of preference of the access bearers in the group of access bearers;
connecting at least one of the external communication modules to the at least one selected access bearer, the at least one external communication module using an access communication technology compatible with the at least one selected access bearer to thereby allow the one or more network nodes of the mobile network to communicate with correspondent nodes of the communication network via the access gateway provided by the at least one selected access bearer;
continuously determining the availability of the one or more access bearers from the group of access bearers; and
determining whether the selected access bearer is the most preferred access bearer in the prioritized list of access bearers.
